(19) United States
(12) Patent Application Publication
(10) Pub. No.: US 2021/0184839 A1
(43) Pub. Date: Jun. 17, 2021

(54) SECURE COMMUNICATION METHOD

(71) Applicants: AIRBUS DEFENCE AND SPACE SAS, TOULOUSE Cedex 4 (FR); CASSIDIAN CYBERSECURITY SAS, ELANCOURT (FR)

(72) Inventors: Nicolas PABST, ELANCOURT (FR); Vincent DUPUIS, RUEIL MALMAISON (FR); Julien FRANCQ, SAINT-CYR L'ECOLE (FR); Paul-Emmanuel BRUN, NOISY LE ROI (FR)

(21) Appl. No.: 16/771,524

(22) PCT Filed: Dec. 10, 2018
(86) PCT No.: PCT/EP2018/084203

§ 371 Date: Jun. 10, 2020

(30) Foreign Application Priority Data
Dec. 11, 2017 (FR) 1761950

(51) Int. Cl. H04L 9/08; H04L 9/06; H04L 9/32

(52) U.S. Cl. CPC H04L 9/0819; H04L 9/3226; H04L 9/0866; H04L 9/0656

(57) ABSTRACT

A secure communication method between at least one first entity and at least one second entity with a communication link in at least one network, includes a step of encryption, by the first entity, using a symmetric encryption algorithm, of content using a first key specific to the first entity; a step of aggregation, in a message, of the encrypted content with at least one key generation parameter specific to the first entity; a step of sending, by the first entity, of the message to the second entity; a step of determination, by the second entity, of the first key specific to the first entity using the key generation parameter specific to the first entity, of a first secret known by the second entity and of a key generating function; a step of decryption, by the second entity, of the encrypted content of the message received, using the first key.

### TECHNICAL FIELD OF THE INVENTION

The present invention relates to the field of secure communication methods and in particular in networks that integrate connected objects referred to as “IoT” (Internet of Things).

### PRIOR ART

Systems based on connected objects are today highly used and their exploitation should increase. An example is provided by the sensors installed in connected vehicles. These connected sensors are for example used to supervise fleets of vehicles based on the data supplied by the sensors. Another example is supplied by production systems that include functionalities that are dedicated to maintenance or safety. The data supplied by the sensors or probes installed, for example, on a workstation or communication equipment, can be used for the purpose of anticipating maintenance or update periods and thus allow for more effective scheduling of maintenance interventions.

In systems connected by one or several networks, the integrity and the security of the data exchanged remain major points of importance. The conservation of the confidentiality of the information is increasingly reinforced, for example, for strategic reasons or for reasons of personal data protection. Controlling the integrity of data is for example reinforced in the context of cyber-attack threats or in secure environments that correspond to sensitive technological fields.

Communication systems use for example protocols for securing data of the TLS or DTLS type. These protocols are generally used by connected objects of the smartphone type. Implementing these protocols sometimes entails using a large portion of the resources made available by the on-board computers. Such a protocol is not suitable for example for connected objects of the probe type or which have limited computing power. Connected objects can also be limited by their energy reserves, as complex calculations (for example, cryptographic) consume a substantial amount of energy. The calculations are for example deemed to be too complex when the calculation time or energy required for these calculations are not compatibles with operating needs. Networks can also be limited, in terms of resources, their speed or by the hardware resources implemented for communications management. Implementation examples of the DTLS protocol are shown for example in documents RFC5246 or RFC5077.

Other methods propose solutions that are based on network architecture, but these solutions, such as ZigBee or LoRa, generally to not provide end-to-end security.

### TECHNICAL PROBLEM

There is therefore a need to provide a secure communication method that is robust and simple to deploy that retains great flexibility in the management of connected objects.

### SUMMARY OF THE INVENTION

In order to overcome these technical problems, the present proposes a secure communication method between at least one first entity and at least one second entity with a communication link in at least one network comprising:
a step of encryption, by the first entity, using a symmetric encryption algorithm, of content using a first key specific to the first entity;
a step of aggregation, in a message, of the encrypted content with at least one key generation parameter specific to the first entity;
a step of sending, by the first entity, of the message to the second entity;
a step of determination, by the second entity, of said first key specific to the first entity using said key generation parameter specific to the first entity, a first secret known by the second entity and a key generation function;
a step of decryption, by the second entity, of the encrypted content of the message received, using the first key.

According to a particularity, the method comprises an additional step of sending a response to the message, encrypted by the symmetric encryption algorithm using the first key and/or an additional step of erasing the first key in the memory of the second entity.

According to another particularity, the method comprises a prior step of initialising each second entity comprising a memorising of said first secret.

According to another particularity, the method comprises prior steps, namely:
a step of transmission, by each first entity, to a managing entity, of the key generation parameter specific to each first entity in order to obtain a second key;
a step of generating, by the managing entity, each second key specific to each first entity, using said first secret held by the managing entity, said key generation parameter specific to each first entity and said key generation function;
a step of supplying each first key to each first entity;
   the method comprising additional steps, namely:
a step of generating, by each first entity, the first key, by a derivation function, using its second key and at least one derivation parameter,
a step of aggregating, by each first entity, of said derivation parameter to the message intended for the second entity,
a step of derivation, by the second entity, in order to obtain the first key using the second key generated using the first secret and the key generation parameter specific to the first entity supplied as input of said key generation function.

According to another particularity, said derivation parameter comprises at least one random key generated by said first entity.

According to another particularity, the steps of transmitting the generation parameter for the second key and of supplying said second key are carried out by sending a request for obtaining the second key and a response to this request, each first entity being in a communication link with the managing entity in said network.

According to another particularity, the request for obtaining the second key and the response to this request are encrypted using a third key memorised by each first entity and regenerated by the managing entity using a second secret held by the managing entity, said key generation parameter specific to each first entity and said key generation function, the method comprising prior steps, namely:
a step of transmission, by each first entity, to the managing entity, of the key generation parameter specific to each first entity for obtaining the third key;
a step of generating, by the managing entity, each third key specific to each first entity, using said second secret held by the managing entity, said key generation parameter specific to each first entity and said key generation function;
a step of supplying each third key to each first entity.
a step of erasing, in the memory of said managing entity, each third key.

According to another particularity, the transmission by each first entity, to the managing entity, of the key generation parameter specific to each first entity for obtaining the third key is carried out at the same time as an authentication of each first entity with the managing entity.

According to another particularity, the transmission by each first entity, to the managing entity, of the key generation parameter specific to each first entity for obtaining the third key is carried out jointly with the transmission of a public key, this public key and the corresponding private key being memorised by said first entity, the third key thus being encrypted using this public key, by the managing entity, prior to the transmission thereof to said first entity.

According to another particularity, said at least one key generation parameter specific to the first entity comprises at least one identifier of this first entity.

According to another particularity, said at least one key generation parameter specific to the first entity further comprises an expiry date of the key generated by the first entity.

Another object of the invention relates to a secure system for exchanging data between at least one first entity and at least one second entity with a communication link in at least one network, said first and second entities comprising modules for calculating and memorising and network communication interfaces, characterised in that each first entity memorises:
an encrypting and decrypting program using a symmetric encryption algorithm, using a first key and
a program for transmitting aggregated encrypted data with at least one parameter specific to the first entity allowing for a generation of the key,
   and in that each second entity memorises:
a program for regenerating a key using said key generation parameter specific to the first entity and a secret known by the second entity and
an encrypting and decrypting program by said symmetric encryption algorithm, using said first key.

According to another particularity, the system comprises a managing entity comprising a key generation program from said key generation parameter specific to each first entity and from said secret held by the managing entity.

According to another particularity, the managing entity comprising a program for initialising each second entity comprising the initialisation of the first known secret of each second entity.

According to another particularity, the system comprises a plurality of second entities organised into at least one batch, in such a way as to access the same resource by the same batch of second entities that share the same secret.

According to another particularity, each first and second entity comprises a key derivation program according to at least one derivation parameter.

According to another particularity, the system is able to execute the method according to the invention.

A first advantage of the invention resides in the simplicity of its deployment which allows connected objects to simply obtain a main key and one or several auxiliary keys to access one or several resources. The increase in the control units to respond to an extension in client requests is also facilitated. The method according to the present invention thus provides great flexibility in the adaptation thereof.

Another advantage of the invention resides in the implementation of a securing of the data exchanged end-to-end and independently of the type of networks on which the data circulates.

An advantage of the invention further resides in the offsetting of the calculations of the main and auxiliary keys in management entity or in the control entities. Thus the client entities can have the form of connected objects benefitting from low resources, services in terms of latency and speed remaining effective. Moreover, it is not necessary for the management or control entities to memorise all the keys used by all the client entities.

The invention also has the advantage of allowing for encryptions by different client entities using different keys for each one of the clients, without requiring substantial means for managing secure communications.

The invention also has for advantage to allow for a simple renewal of the main and auxiliary keys. In addition the expiration date can be transmitted with the encrypted message as a regeneration parameter of the key used for the encryption.

An advantage of the invention further resides in the fact that the changes made in the encryption keys can be made simply and at several levels according to different frequencies. The derived auxiliary key is for example valid for one day, the auxiliary key remaining for example valid for one week, while the main key can remain valid for two weeks. In addition, the secrets for generations of main and auxiliary keys are never transmitted to the client entities.

Advantageously, it is not necessary for a control entity or for the managing entity to save the different encryption keys used by the different client entities, which makes it possible to save resources and to render the method according to the invention particularly flexible and adaptable to a changing environment.

### LIST OF FIGURES

Other characteristics of the invention will clearly appear in the description of it hereinbelow, for the purposes of information and in no way limiting, in reference to the accompanying figures, among which:

FIG. 1 shows an example of a secure method according to the invention;

FIG. 2 shows an example of data exchanges for the initialisation of a key specific to a client entity that allows it to address encrypted requests to a managing entity;

FIG. 3 shows an example of data exchanges for the initialisation of a key specific to a client entity that allows it to address encrypted requests to a control entity initialised by the managing entity;

FIG. 4 shows an example of secure exchanges between a client entity and a control entity;

FIG. 5 shows an example of a secure system for exchanging data according to the invention.

### DETAILED DESCRIPTION OF THE INVENTION

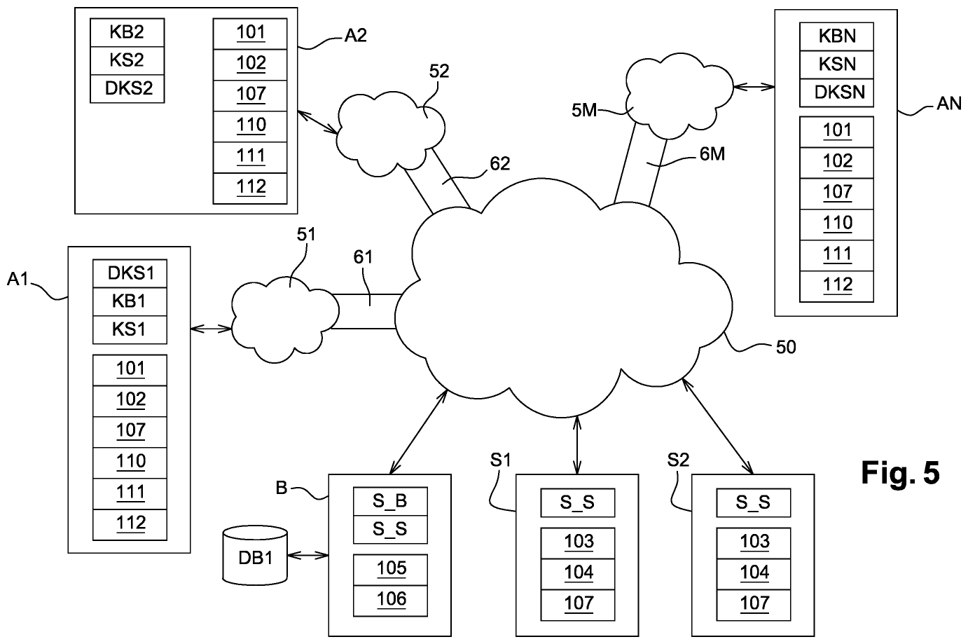

As shown in FIG. 5, a managing entity B is connected to a communication network 50. Several control entities S1 and S2 are also connected to this communication network 50. This latter network 50 is connected moreover to other networks 51, 52 and 5M via gateways 61, 62 and 6M. Client entities A1, A2 and AN can thus be in a communication link with the control entities S1 and S2 and with the managing entity B. The number of client entities can vary, the number of control entities can then be consequently increased or decreased. A control entity is for example created or cancelled by the managing entity B. The managing entity, the client entities and the control entities each include calculation modules, memorisation modules and network communication interfaces.

One or several control entities S1 and S2 allow for example access to a resource. Different types of control entities grouped into different batches to access different resources can also be considered. An accessed resource is for example of the application, database, library, access manager, authentication manager or log manager type. The control entity is for example of the reverse proxy type. The control entity can for example be of the gateway type. The augmentation in the number of control entities, in the same batch, to access the same resource allows a greater number of client entities to simultaneously access this resource. In the same batch, a new control entity can be created to respond to a more substantial volume of requests. The new control entity sera for example created by the managing entity that will transfer to it an identical auxiliary secret within the same batch. Such a new control entity can also be created based on an existing control entity.

Each control entity memorises an auxiliary secret S_S, a key regeneration program 103, an encryption and decryption program 104 by symmetric encryption algorithm as well as a key derivation program 107. The derivation program is for example of the HKDF type. The key generation program can for example can have the form of a derivation protocol of the secret such as NIST-800-108-KDF, X9.63-KDF, NIST-800-56-KDF-A/B, NIST-800-56-KDF-C or HKDF.

The client entities A1, A2 and AN are for example smartphones, computers, tablets, connected probes, connected sensors, connected actuators or other connected instruments. Each client entity memorises namely an encrypting and decrypting program 101 using a symmetric encryption algorithm, an aggregated encrypted data transmission program 102 with parameters intended to allow for decryption and a key derivation program 107. As shown in FIG. 5, each client entity also memorises a program 110 for encrypting/decrypting by asymmetric keys, a program 111 for generating a random key and a time-date stamp program 112. The derivation program is for example of the HKDF type. The client entity Al further memorises a main key KB1, an auxiliary key KS1 and a derived auxiliary key DKS1. The client entity A2 further memorises a main key KB2, an auxiliary key KS2 and a derived auxiliary key DKS2. The client entity AN further memorises a main key KBN, an auxiliary key KSN and a derived auxiliary key DKSN. As detailed in what follows each client entity can hold main and auxiliary keys that are specific to it.

The managing entity B holds the main secret as well as the auxiliary secrets. The auxiliary secrets can namely be created according to need. The managing entity memorises a key generation program 105, a program 106 for initiating control entities. The managing entity can also carry out an authentication of the client entities thanks to a database DB1. The key generation program can for example have the form of a derivation protocol of a secret such as NIST-800-108-KDF, X9.63-KDF, NIST-800-56-KDF-A/B, NIST-800-56-KDF-C or HKDF.

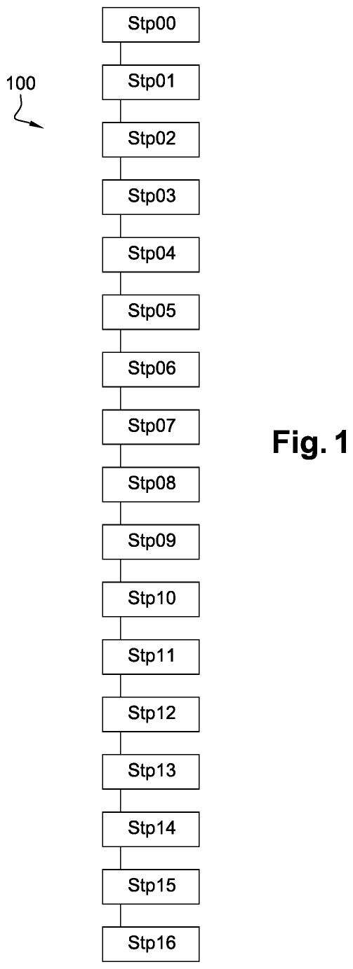

The example of the secure method according to the invention, such as shown in FIG. 1, comprises a step Stp00 of initialising one or several control entities (S1, S2) comprising an initialisation of their auxiliary secret S_S. This step can be reiterated during the process, according to need.

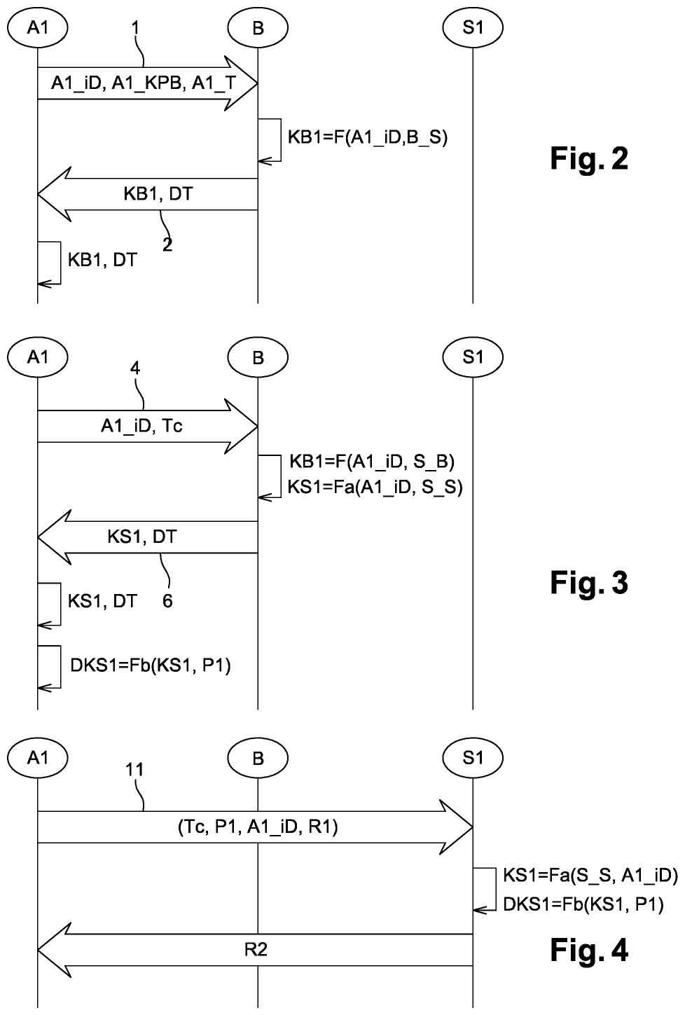

A following step Stp01 comprises the transmission by the client entity A1, to the managing entity B, of a key generation parameter A1_ID that is specific to it for the obtaining of a main key jointly with the transmission of a public key. This transmission can be carried out during an authentication with the managing entity or by a request to obtain a main key. The parameter or parameters transmitted for the key generation comprise for example an identifier A1_ID of the client entity A1. The key generation parameters can also comprise a random key, a time of sending or of receiving or a validity date, in such a way as to guarantee the uniqueness of the main key generated. All of the aggregated generation parameters have for example a size less than or equal to 32 bits in order to optimise the bandwidth and the calculation times. As shown in FIG. 2, the request 1 can also comprise a public key A1_KPUB memorised with a private key by the client entity A1. The request for obtaining the main key can also comprise a time-date stamp A1_T.

In a following step Stp02, the managing entity B generates the main key KB1 specific to the client entity A1.

KB1=F(B_S, A1_ID)

The main key KB1 is obtained by a key generation function F using the main secret B_S and at least one generation parameter such as the identifier A1_ID of the client entity A1. The derivation parameter can also comprise a random key, a time-date stamp corresponding to the sending of the request or to the arrival of the request or to a validity date. This key KB1 generated is for example encrypted using the public key received A1_KPUB before the transmission thereof to the client entity. A time shift DT with respect to the internal clock of the managing entity B is also calculated using the time-date stamp A1_T. This offset DT is aggregated to the main key KB1, in the response 2 to the client entity A1. The main key KB1 generated is for example associated with an expiration time window of the key memorised in the database DB1. When a lapse of time that exceeds the expiration time window has elapsed, the key is then revoked. This makes it possible to periodically renew the keys used and to increase the security of the method.

In a following step Stp03, the managing entity B carried out the transmission of the main key KB1 in its response 2 to the request 1. After transmission, this key KB1 is for example erased from the memory of the managing entity B.

In a following step Stp04, the client entity Al receives the main key KB1, optionally decrypts it using its private key then stores it in memory. The client entity also memorises the time shift received DT that corresponds to the time difference calculated between the send time of the request and the time it was received. The time difference DT memorised by the client entity A1 is used to correct a shift between the clock of the client entity A1 and the clock of the managing entity B.

In a following step Stp05 a transmission is carried out, from the client entity A1, to the managing entity B, of the specific key generation parameter for the obtaining of an auxiliary key KS1 specific to the client entity A1. This transmission is for example carried out in the form of a request 4 encrypted using the main key KB1 aggregated to one or more parameters A1_ID for the generation of the main key. The managing entity B is then able to decrypt thanks to the main key KB1 generation parameter or parameters supplied and specific to the client entity A1, while still authenticating the origin of the request. A time parameter for emitting the corrected request Tc that takes account of the time difference DT between the clock of the client entity A1 and that of the managing entity B is also aggregated to the request 4. The request for obtaining an auxiliary key comprises at least one key generation parameter A1_ID specific to the first entity A, such as for example the identifier of the client entity A1. Other parameters such as random keys, time-date stamps or a validity date can also be used. All the aggregated generation parameters have for example a size less than or equal to 32 bits in order to optimise the bandwidth and the calculation times.

In a following step Stp06, the generation, by the managing entity B, of the auxiliary key KS1 specific to the client entity A1 is carried out, using said auxiliary secret S_S held by the managing entity B, the key generation parameter or parameters A1_ID specific to the client entity A1 and said key generation function F.

KS1=F(S_S, A1_ID)

The managing entity B verifies namely the validity of the request 4, by checking that the request has arrived before the expiry of a validity time window of the request, according to the corrected emission time Tc. Attacks of the “replay” type are this avoided.

The managing entity furthermore calculated the main key KB1 specific to the client entity A1 so as to decrypt the request 4. The auxiliary key KS1 generated is for example encrypted by the main key KB1 specific to the client entity A1 before the transmission thereof. The same key KB1 is thus used for the encrypting in the request and in the response to this request.

KB1=F(S_B, A1_ID)

In a following step Stp07, a supplying is carried out of the auxiliary key KS1 to the client entity A1, in response 6 to the request 4. After transmission, the auxiliary key KS1 and the main key KB1 generated hereinabove are erased from the memory of the managing entity B. The management entity B can also aggregate to the response 6 an updated value of the time difference DT between the send time of the request by the client entity A1 and the receive time by the managing entity B.

In a following step Stp08, the receiving, decrypting and memorising of the specific auxiliary key KS1 by the client entity A1 are carried out. The decrypting is carried out thanks to the main key KB1 memorised by the client entity. Thus the managing entity B was able to send a message encrypted by a key which is held only by the client entity A1 for which the message was intended. Each client entity A1, A2, AN memorises, at the same time as the different keys, their generation parameter or parameters. A time parameter, a random key and/or an expiration date used to generate the key are for example memorised. The updated time shift DT is also memorised by the client entity A1.

In a following step Stp09, a generating of a derived key DKS1 from the auxiliary key and the memorising thereof are carried out. The derivation is carried out using the auxiliary key KS1 memorised and at least one derivation parameter P1, such as a random key generated by the random key generation program 111. This or these derivation parameters are memorised at the same time as the key. An expiration data or a creation date can also be used as derivation parameters.

DKS1=Fb(KS1, P1)

In a following step Stp10, the encrypting of a content intended for the control entity is carried out by using the derived auxiliary key DKS1.

In a following step Stp11 an aggregation is carried out in a message M, of the encrypted content R1 with the auxiliary key KB1 generation parameter or parameters A1_ID specific to the first entity A1 and with the derivation parameter or parameters P1. The send time Tc or the corrected send time can also be integrated into the message M.

In a following step Stp12, the sending, by the client entity A1, of the message M to the control entity S1 is carried out. During the reception, the control entity can in particular determine if the request has reached it in an authorised time window and thus prevent attacks of the “replay” type.

In a following step Stp13, a determination is carried out, by the control entity S1, of the encryption key by
generation of the auxiliary key KS1 using the auxiliary secret S_S and the key generation parameter or parameters A1_ID specific to the client entity A1 supplied as input of a key generation program then
derivation of this latter key KS1, using the derivation parameter or parameters P1 and the derivation function to obtain the derived auxiliary key DKS1 used to encrypt the content R1 of the message.

KS1=Fa(S_S, A1_ID)

DKS1=Fb(KS1, P1)

In a step Stp14, a decrypting of the encrypted content R1 of the message M received is carried out.

In a step Stp15, the sending is carried out of a response to the message, with the response comprising a content R2 encrypted by the symmetric encryption algorithm using the derived auxiliary key DKS1 regenerated hereinabove.

In a step Stp16, an erasing is carried out of the auxiliary key KS1 and of the derived auxiliary key DKS1 in memory of the control entity S1.

The scope of the invention is not left when the client entity directly uses the auxiliary key KS1 to encrypt the content of the message sent to the control entity, the control entity using only the auxiliary key generation parameter or parameters to regenerate the auxiliary key KS1 and decrypt the content of the message received.

It must be obvious for those skilled in the art that the present invention allows for other alternative embodiments. Consequently, the present embodiments must be considered as illustrating the invention.

1. A secure communication method between at least one first entity and at least one second entity with a communication link in at least one network comprising:
a step of encryption, by the first entity, using a symmetric encryption algorithm, of content using a first key specific to the first entity;
a step of aggregation, in a message, of the encrypted content with at least one key generation parameter specific to the first entity;
a step of sending, by the first entity, of the message to the second entity;
a step of determination, by the second entity, of said first key specific to the first entity using said key generation parameter specific to the first entity, a first secret known by the second entity and a key generating function;
a step of decryption, by the second entity, of the encrypted content of the message received, using the first key.

2. The method according to claim 1, further comprising a step of sending a response to the message, encrypted by the symmetric encryption algorithm using the first key and/or an additional step of erasing the first key in the memory of the second entity.

3. The method according to claim 1, further comprising a prior step of initialising each second entity comprising a memorising of said first secret.

4. The method according to claim 1, further comprising prior steps, that are:
a step of transmission, by each first entity, to a managing entity, of the key generation parameter specific to each first entity in order to obtain a second key;
a step of generating, by the managing entity, each second key specific to each first entity, using said first secret held by the managing entity, said key generation parameter specific to each first entity and said key generation function;
a step of supplying each first key to each first entity;
the method comprising additional steps, that are:
a step of generating, by each first entity, the first key, by a derivation function, using its second key and at least one derivation parameter,
a step of aggregating, by each first entity, of said derivation parameter to the message intended for the second entity,
a step of derivation, by the second entity, in order to obtain the first key using the second key generated using the first secret and the key generation parameter specific to the first entity supplied as input of said key generation function.

5. The method according to claim 4, wherein said derivation parameter comprises at least one random key generated by said first entity.

6. The method according to claim 4, wherein the steps of transmitting the generation parameter for the second key and of supplying said second key are carried out by sending a request for obtaining the second key and a response to said request, each first entity being in a communication link with the managing entity in said network.

7. The method according to claim 6, wherein the request for obtaining the second key and the response to said request are encrypted using a third key memorised by each first entity and regenerated by the managing entity using a second secret held by the managing entity, said key generation parameter specific to each first entity and said key generation function, the method comprising prior steps, that are:
a step of transmission, by each first entity, to the managing entity, of the key generation parameter specific to each first entity for obtaining the third key;
a step of generating, by the managing entity, each third key specific to each first entity, using said second secret held by the managing entity, said key generation parameter specific to each first entity and said key generation function;
a step of supplying each third key to each first entity.
a step of erasing, in the memory of said managing entity, each third key.

8. The method according to claim 7, wherein the transmission by each first entity, to the managing entity, of the key generation parameter specific to each first entity for obtaining the third key is carried out at the same time as an authentication of each first entity with the managing entity.

9. The method according to claim 6, wherein the transmission by each first entity, to the managing entity, of the key generation parameter specific to each first entity for obtaining the third key is carried out jointly with the transmission of a public key, said public key and the corresponding private key being memorised by said first entity, the third key thus being encrypted using said public key, by the managing entity, prior to the transmission thereof to said first entity.

10. The method according to claim 1, wherein said at least one key generation parameter specific to the first entity comprises at least one identifier of said first entity.

11. The method according to claim 10, wherein said at least one key generation parameter specific to the first entity further comprises an expiry date of the key generated by the first entity.

12. A secure system for exchanging data between at least one first entity and at least one second entity with a communication link in at least one network, said first and second entities comprising modules for calculating and memorising and network communication interfaces, wherein each first entity memorises:
an encrypting and decrypting program using a symmetric encryption algorithm, using a first key and
a program for transmitting aggregated encrypted data with at least one parameter specific to the first entity allowing for a generation of the key,
and wherein each second entity memorises:
a program for regenerating a key using said key generation parameter specific to the first entity and a secret known by the second entity and
a program for encrypting and decrypting by said symmetric encryption algorithm, using said first key.

13. The system according to claim 12, further comprising a managing entity comprising a key generation program from said key generation parameter specific to each first entity and said secret held by the managing entity.

14. The system according to claim 13, wherein the managing entity comprising a program for initialising each second entity comprising the initialisation of the first known secret of each second entity.

15. The system according to claim 14, further comprising a plurality of second entities organised into at least one batch, in such a way as to access the same resource by the same batch of second entities that share the same secret.

16. The system according to claim 12, wherein each first and second entity comprises a key derivation program according to at least one derivation parameter.

17. A system configured to execute the method according to claim 1.
